(19) United States
(12) Patent Application Publication
(10) Pub. No.: US 2010/0233224 A1
(43) Pub. Date: Sep. 16, 2010

(54) PHOTOLYTIC RELEASE OF BIOCIDES FOR HIGH EFFICIENCY DECONTAMINATION THROUGH PHOSPHOLIPID NANOPARTICLES

(75) Inventors: Dinakar RAMADURAI, Chicago, IL (US); William Christopher OROSZ, Chicago, IL (US); James W. GARLAND, Aurora, IL (US)

Correspondence Address: Momkus McCluskey, LLC, 1001 Warrenville Road, Suite 500, Lisle, IL, 60532, US

(73) Assignee: EPIR TECHNOLOGIES, INC., Bolingbrook, IL (US)

(21) Appl. No.: 12/390,889

(22) Filed: Feb. 23, 2009

(51) Int. Cl. A01N 25/26; A01P 1/00

(52) U.S. Cl. 424/420; 424/616

(57) ABSTRACT

Biocide-filled liposome vesicles containing one or more photosensitizers are located in one or more areas for potential sterilization. Upon receiving one or more signals, the liposome vesicles are irradiated with light causing the membrane of the vesicles to break, thereby releasing the biocidal agent or agents which are distributed throughout the area. Preferred biocidal agents are hydrogen peroxide, benzalkonium chloride, and photo-oxidizing nanoparticles such as titanium dioxide, iron oxide, and certain commercially available biocides such as Ucarcide 25 and Ucarcide 50 from Dow Chemical Co.

In an alternative embodiment, upon receiving a signal, the liposome vesicles are distributed throughout the area and then irradiated with light.

### STATEMENT OF GOVERNMENT INTEREST

This invention was made with Government support under U.S. Army contract #W9132T-08-C-0009. The government has certain rights in this invention. The basic concept for the invention described herein was conceived during the funding provided by the above grant.

### BACKGROUND OF THE INVENTION

Biological agents such as bacteria, viruses, protozoa, and fungi are the cause of increasing concern by both government agencies and private security firms. Such biological agents can be difficult to detect, have drastic long-term effects, and can be dispersed quickly on a large scale. In addition, since the biological agents are often airborne, they will settle on surfaces and remain in the air making the traditional methods for cleaning up biological agents dangerous, labor intensive, time consuming, and expensive. Thus, there is a need for a system that provides a rapid release of a biocidal composition that is as pervasive as the biological agents themselves but reduces the risks to the user.

Liposomes are spherical vesicles consisting of a lipid bilayer and an enclosed aqueous space. By incorporating chemical or biochemical substances in the aqueous phase of the suspension in which the liposomes are formed, liposomes can be obtained that enclose biologically and chemically active substances within their interior space.

Liposomes are sometimes classified as nanoparticles, which typically vary in size from about 25 nanometers to about 1 micrometer in diameter depending on how they are produced and the content of their lipid layer. Liposomes, therefore, can be used as delivery vehicles for various water-soluble substances and for various applications. Since charged molecules generally do not penetrate lipid bilayers and since large molecules penetrate such layers only slowly, the liposome wall acts to insulate an organism to whom the liposomes have been administered from too rapid an effect by the enclosed material and for this reason liposomes are being extensively used for drug delivery applications and for modulating immune response in animals by administering liposomes coated with specific antigens.

The composition of liposome carriers can be modified to facilitate an on-demand release in response to environmental conditions or external stimuli. Acidic pH induced release is the most common form of release for in vivo applications such as sustained drug delivery and also supports a relatively slow release rate. However, for rapid on-demand release, a photo-triggering mechanism offers the fast release kinetics. Stimulated photo release of glucose from 1,2-Dipalmitoyl-sn-Glycero-3-Phosphocholine (“DPPC”) liposomes has been demonstrated using zinc phthalocyanine (“ZnPc”) photosensitizers.

DPPC (Molecular formula: C₄₀H₈₀NO₈P) is a phospholipid and is commonly used in the synthesis of liposomes for biological research and applications. Photoinduced oxidation of lipids in both natural and synthetic membranes is known to result in chain scission and decomposition. ZnPc is known to oxidize unsaturated phospholipids in the presence of light and oxygen through peroxidation of lipid chains. Photo-oxidation of liposomes synthesized using DPPC phospholipids embedded with ZnPc and carrying a mixture of biocidal decontaminants can be triggered to release its load on-demand and rapidly through an external light stimulus (light of wavelength 640 nanometers).

### SUMMARY OF THE INVENTION

This invention relates to a biological decontamination technology, in particular to a method for rapidly and automatically triggering the release of biocidal decontaminants on-demand for the neutralization of biological pathogens in air and on surfaces.

According to one aspect of the invention, the invention is a biocidal composition for sterilizing surfaces or volumes of fluids using phospholipid liposome vesicles containing one or more biocides within the liposome and one or more photosensitizers within the membrane of the liposome.

In a preferred embodiment, the biocidal agent is a mixture of hydrogen peroxide, alkyldimethylbenzylammonium chloride, and certain photo-oxidizing nanoparticles such as titanium dioxide (TiO₂) and iron oxide (Fe₂O₃), the phospholipid is DPPC, dimyristoylphosphatidylcholine (DMPC) and dilauroylphosphatidylcholine (DLPC) and the photosensitizer is ZnPc, bacteriochlorophyll (“BChl”), or bacteriochloriin.

More preferably, the biocidal composition contains multiple liposome vesicles carrying different biocides or different types of photosensitizers. Alternatively, the biocidal composition may contain different photosensitizers and different biocides.

In another aspect, the invention is a method for sterilizing surfaces or fluid volumes by formulating a plurality of liposome vesicles with one or more photosensitizers within the membrane and containing a biocidal composition within, locating an amount of the composition in an area for potential sterilization, irradiating the composition with a light source, which causes the liposomes to release their contents, and, finally, distributing the biocidal agent.

In a preferred embodiment, the composition is located in an HVAC system, one or more rooms in a building, or possibly in a reservoir.

More preferably, the biocidal composition contains multiple liposome vesicles carrying different biocides and different photosensitizers, which allows the liposome vesicles to be activated individually, in a sequence, or all at once as the individual formulating the composition preselects.

Even more preferably, approximately 70% of the biocide is released within 2 minutes.

In another aspect, the invention is a method for sterilizing surfaces or fluid volumes by formulating a biocidal composition within a liposome containing a photosensitizer within the membrane, locating an amount of the composition in an area for potential sterilization, and, upon receiving a signal, distributing the liposome vesicles throughout the area. Then, upon receiving a second signal, irradiating the liposome vesicles, causing the liposome vesicle membranes to fail and the biocidal agents to be released.

Even more preferably, approximately 70% of the biocide is released within 2 minutes and 98% of the biocidal agent is released within 16 minutes.

### BRIEF DESCRIPTION OF THE DRAWINGS

Further aspects of the invention and their advantages can be discerned in the following detailed description, in which like characters denote like parts and in which:

FIG. 1 depicts a scheme for photolytic release of biocides from encapsulated liposome vesicles;

FIG. 2 depicts an image of liposome vesicles suspended in a buffer. The vesicle suspension was held in a liquid cell while they were imaged using the microscope;

FIG. 3 depicts liposome vesicles immobilized on the surface of a glass slide;

FIG. 4 depicts the relative intensities of released ZnPc as a function of time at two minute intervals;

FIG. 5 depicts the emission spectra before and after decontamination of E. coli bacteria using the Live/Dead BacLight assay;

FIG. 6 depicts a method for the decontamination of an area; and

FIG. 7 depicts an alternate method for the decontamination of an area.

### DETAILED DESCRIPTION

As used in the Specification, the following terms have the following definitions.

The term “liposome vesicle” as used herein means a fluid-filled lipid bilayer membrane enclosing a volume of fluid.

The term “vesicle” as used herein means a relatively small intracellular, membrane-enclosed body that stores or transports fluids.

The term “phospholipid” as used herein means any of a group of fatty compounds composed of phosphoric esters.

The term “phospholipid bilayer” as used herein means two layers of lipids arranged so that their hydrocarbon tails face one another to form an oily core, while the charged heads face the aqueous solutions on either side of the membrane.

The term “photosensitizer” as used herein means and substance that causes oxidation and/or chain scission or decomposition when subjected to one or more frequencies of light. Photosensitizers suitable for use with the invention are those which cause the liposome vesicle to release the biocidal agent upon irradiation with light including a predetermined wavelength or wavelengths.

The term “photo-oxidation” as used herein means oxidation by a photosensitizer of the unsaturated bonds in phospholipids in the presence of light and oxygen.

The term “activate” as used herein means initiation of the photo-oxidation process that ultimately causes the membrane of the lipsome vesicles to break.

The term “biocidal agent” as used herein means any compound that kills, decreases the toxicity of, or slows the growth of fungi, viruses, protozoa, bacteria, spores, or algae. Nonlimiting examples include Ucarcide 25 and Ucarcide 50 available from Dow Chemical Co.

The term “HVAC system” as used herein means any heating, ventilation, and air conditioning system or portion thereof including, but not limited to, ducts, blowers, and filters.

The term “benzalkonium chloride” as used herein means any alkyldimethylbenzylammonium chloride.

The term “pathogen” as used herein means any disease-producing agent, especially a virus, bacterium, or other microorganism.

The term “irradiator” as used herein means any device capable of emitting one or more frequencies of light.

The composition of liposome carriers can be modified to facilitate on-demand release in response to environmental conditions or external stimuli. Acidic pH induced release is the most common form of release for in vivo applications such as sustained drug delivery and also supports a relatively slow release rate. However, we have determined that where a rapid on-demand release is required, a photo-triggering mechanism offers the ideal fast release kinetics required for decontamination of biological pathogens through biocidal decontaminants that are stored inside the liposomes.

The inventors have discovered a biocidal composition that may be used for sterilizing surfaces of volumes of fluids. The composition comprises one or more phospholipid liposome vesicles surrounding one or more biocidal agents. Additionally, the liposome membrane contains one or more photosensitizers that, when irradiated with one or more frequencies of light, oxidize the unsaturated phospholipids. Preferred biocidal agents include, but are not limited to hydrogen peroxide, alkyldimethylbenzylammonium chloride, and combinations thereof. Suitable examples of phospholipids are DPPC or 1-alk-1′-enyl-2-palmitoyl-sn-glycero-3-phosphocholine (“PlasPPC”). Photosensitizers may include, but are not limited to zinc phthalocyanine, bacteriochlorophyll, bacteriochloriin, and combinations thereof.

In a preferred embodiment, the biocidal agent is a mixture of hydrogen peroxide, alkyldimethylbenzylammonium chloride, and certain photo-oxidizing nanoparticles such as titanium dioxide (TiO₂) and iron oxide (Fe₂O₃), the phospholipid is DPPC, dimyristoylphosphatidylcholine (DMPC) and dilauroylphosphatidylcholine (DLPC) and the photosensitizer is ZnPc, bacteriochlorophyll (“BChl”), or bacteriochloriin.

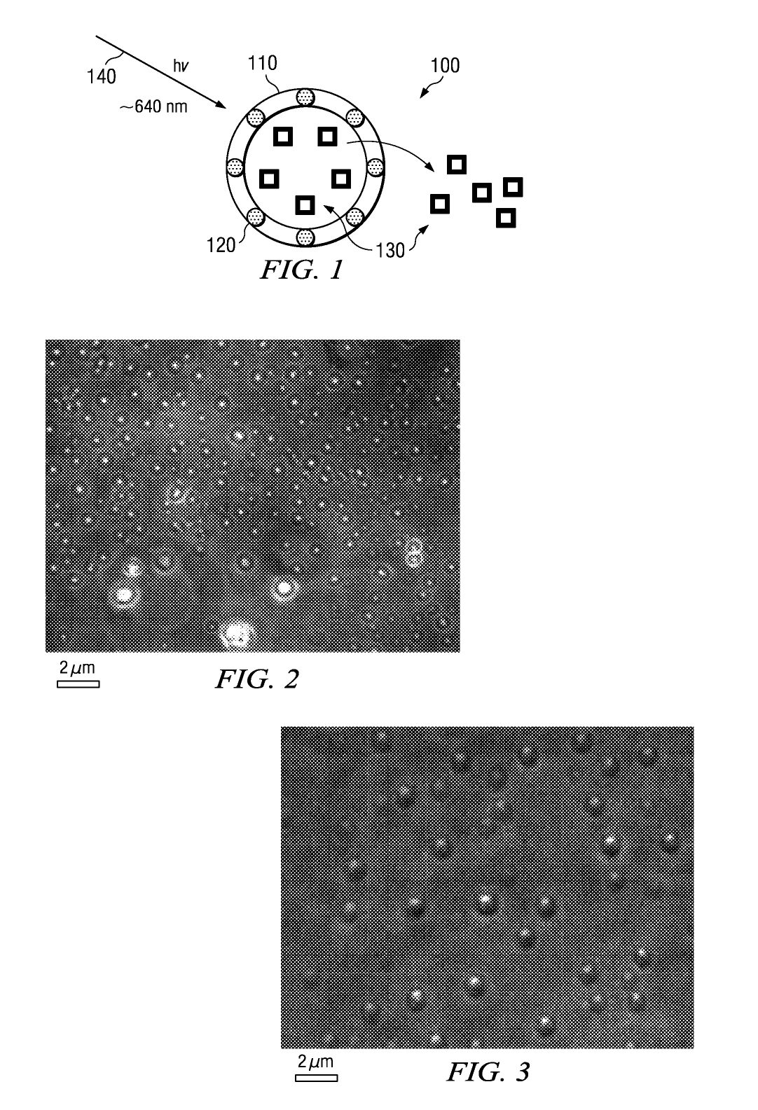

FIG. 1 depicts the photolytic release of biocides 130 from an encapsulated liposome vesicle 100. When the liposome vesicle 100 is irradiated with light 140 of a specific wavelength, the photosensitizers 120 embedded within the liposome vesicle membrane 110, causing photo-oxidation and failure of the membrane 110, in turn causing the release of the biocides 130.

Preferred embodiments of the invention include a mixture of hydrogen peroxide and benzoalkonium chloride as the biocidal agents. Hydrogen peroxide has strong oxidation properties and decomposes to oxygen and water, making it environmentally safe. Benzoalkonium chloride is preferred as to at least one of the biocidal agents because it is soluble in water and does not foam easily. Especially preferred variants are where the alkyl group is a C₁₂-C₁₄ alkyl derivative. Additionally, other biocides and combinations of biocidal agents may be used with or in place of hydrogen peroxide and benzoalkonium chloride. The biocides should be effective against viruses, fungi, bacteria, spores, protozoa, algae, or combinations thereof.

The liposome vesicle membranes may contain one photosensitizer or multiple sensitizers that are activated by irradiation with light having different wavelengths. Alternatively, a first group of liposome vesicles may contain a first combination of biocidal agents and a first photosensitizer sensitive to a first wavelength and a second group of liposome vesicles may contain a second different combination of biocidal agents and a second photosensitizer sensitive to a second wavelength. The first and second group of biocidal agents may be the same or different and the first and second sensitizers may be the same or different.

These different combinations of biocides and photosensitizers allows the activation of the groups of vesicles individually, in a particular sequence, or all at once, thereby controlling the timing, type, and amount of the biocide released. This is particularly advantageous since it allows the user to tailor the decontamination to the type and severity of the threat detected.

Since vesicles can have the same biocide but different photosensitizers, it is contemplated that the same biocide can be released repeatedly by irradiating the liposome vesicles with different wavelengths of light at different times.

Further, the liposome vesicles may include surfactants, stabilizers, nutrients, thickeners, gels, colloids, coagulants, thinners, dyes, or combinations thereof as additives.

Briefly, the procedure for a small-scale synthesis of liposomes involves heating (for approximately 15 minutes) the lipid mixture to a temperature above the phase transition temperature of the lipid, followed by hydration in Tris buffer for 30 minutes. This step is followed by 3-5 freeze/thaw cycles for complete hydration of the lipids by alternating between a dry ice bath and a warm water bath. Once the lipids are completely hydrated, the sample is extruded through a column by loading a syringe through the extruder. The vesicles that are formed through this procedure are collected with the help of a clean syringe and are stored at the correct pH (˜8.0).

In order to synthesize larger liposome vesicles for photolytic release, EPIR has employed a somewhat modified protocol called the Large Unilamellar Vesicles by Extrusion (hereinafter, referred to as LUVET) method. This method uses a mini-extruder and 0.8 μm polycarbonate membrane filters for synthesizing uniformly distributed large vesicles. The mini-extruder and filters are available from Avanti Polar Lipids. The detailed procedure for a small-scale synthesis of large photolytic liposomes loaded with biocide is as follows.

One gram of dry DPPC (purchased from Avanti Polar Lipids Inc.) is dissolved in a chloroform solution and dried to a film for 24 hours under a stream of inert nitrogen gas. The lipid is then dried under vacuum for 2 hours to remove entrapped solvents. The photosensitizer is introduced into the liposome film by preparing an ethanolic stock solution of ZnPc (purchased from Sigma) through dilution in a 5 mM pyridine solution. 200 μl of the ZnPc solution is added to 2.8 ml of 20 mM Tris buffer (pH 8.0) containing 165 mg of hydrogen peroxide and benzalkonium chloride (0.3 M). All chemicals were obtained from Sigma Co. This solution was used to hydrate the lipid film. The suspension is warmed to 45° C. (˜30 mins) in a standard water bath, vortexed and put through five freeze-thaw cycles by alternating between a dry ice container and a water bath. Necessary precautions should be taken to maintain the lipid suspension at temperatures above the phase transition temperature of DPPC (T_{c}=41° C.) throughout the hydration and extrusion procedures.

The mini extruder from Avanti Polar Lipids Inc. is placed on a heating block and a thermometer is inserted into the well to monitor the temperature during the extrusion procedure. The heating block is brought up to 45° C. by warming it on a calibrated hot plate (approximately 15 mins).

Finally, the suspension was extruded through the mini-extruder through stacked polycarbonate membrane filters (19 mm in diameter).

Excess ZnPc, which remained unentrapped in solution, is removed through multiple vortex cycles and aspirating the supernatant. Alternatively, a buffer-equilibrated column separator can be used to enable a single step separation of excess ZnPc.

The liposome vesicles are collected in a capped glass vial and stored in the dark until characterization. FIG. 2 shows the image of the liposome vesicles placed in a liquid cell and imaged using a Nikon E 600 microscope. In this case, the vesicles were free floating in the buffer while they were imaged using the microscope and camera. FIG. 3 shows an image of the liposomes dried on a glass substrate where the buffer had evaporated and imaged using a similar setup.

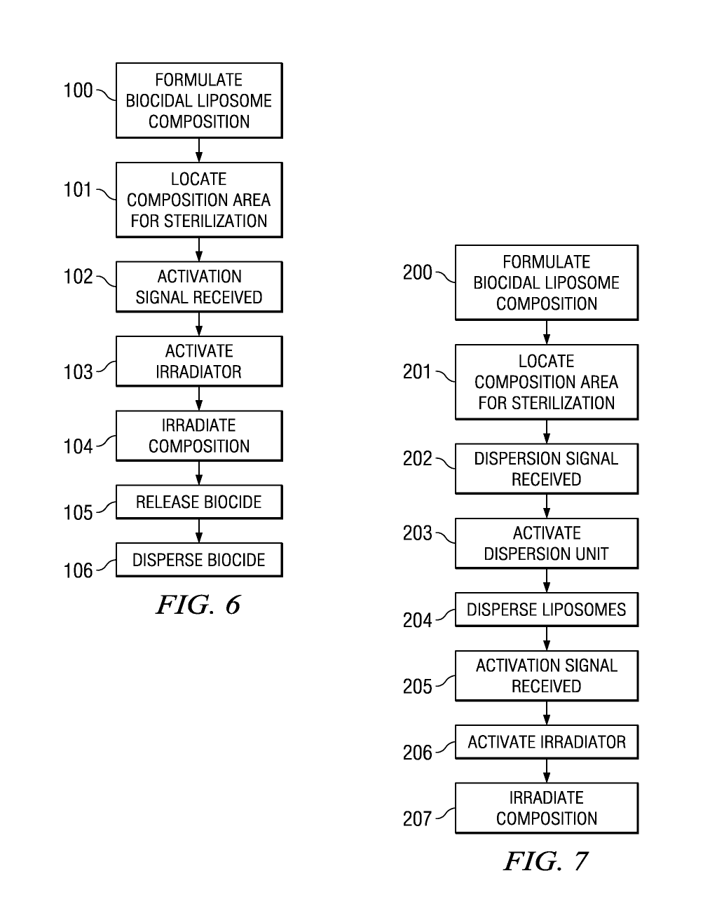

Steps in a first method according to the invention are shown in FIG. 6. In practice, a desired biocidal liposome vesicle composition is formulated (100) and an amount of the composition is located (101) in an area where sterilization may be required. The area for sterilization may be surfaces or volumes in office buildings, HVAC systems, or reservoirs. Once the composition is in place, an activation signal is received (102) causing the activation (103) of an irradiator, which emits (104) one or more wavelengths of light. The irradiated liposome vesicles photo-oxidize and the membranes of the vesicles break, releasing (105) the biocidal agent or agents. The biocidal agents are then dispersed (106) over the surfaces or volumes to be decontaminated. Distribution methods include but are not limited to diffusion, osmosis, spraying, vaporization, through an aerosol, and combinations thereof. This method has the advantage that the liposome vesicles are already broken before being dispersed, therefore eliminating the need to irradiate the entire area.

The activation signal generated at step 103 may be manually, timed, or in response to the detection of one or more pathogens.

In an alternative embodiment, shown in FIG. 7, a desired biocidal liposome vesicle composition is formulated (200) and an amount of the composition is located (201) in an area where sterilization may be required. Once the composition is in place, a dispersion signal is received (202), causing the activation (203) of a liposome vesicle dispersion device. The vesicles are then dispersed (204) throughout the area and an activation signal is received (205), causing the activation (206) of an irradiator, which emits one or more wavelengths of light thereby irradiating (207) the vesicles. The irradiated liposome vesicles photo-oxidize and the membranes of the vesicles break, releasing the biocidal agent or agents.

As with the first method described, the activation and dispersion signals may be generated manually, timed, or in response to the detection of one or more pathogens. During the formulation step, the biocides discussed above may need to be mixed, possibly forming an emulsion. Finally, the dispersion device may be an aerosol device, fan, blower, or gravity.

### Example 1

### Biocide Release

This example demonstrates the fast triggered release of biocides from the liposome vesicles. The photo triggered release was achieved by exposure of the ZnPc embedded liposomes to 640 nm light from a laser and aliquoting 25 μl of solution from the suspension at regular intervals (after 0 mins, 2 mins, 4 mins, 6 mins, 8 mins, 10 mins, 12 mins, 14 mins and 16 mins) and measuring the signal from the samples through a FluoroMax-4 Spectrofluorometer from Horiba Jobin-Yvon.

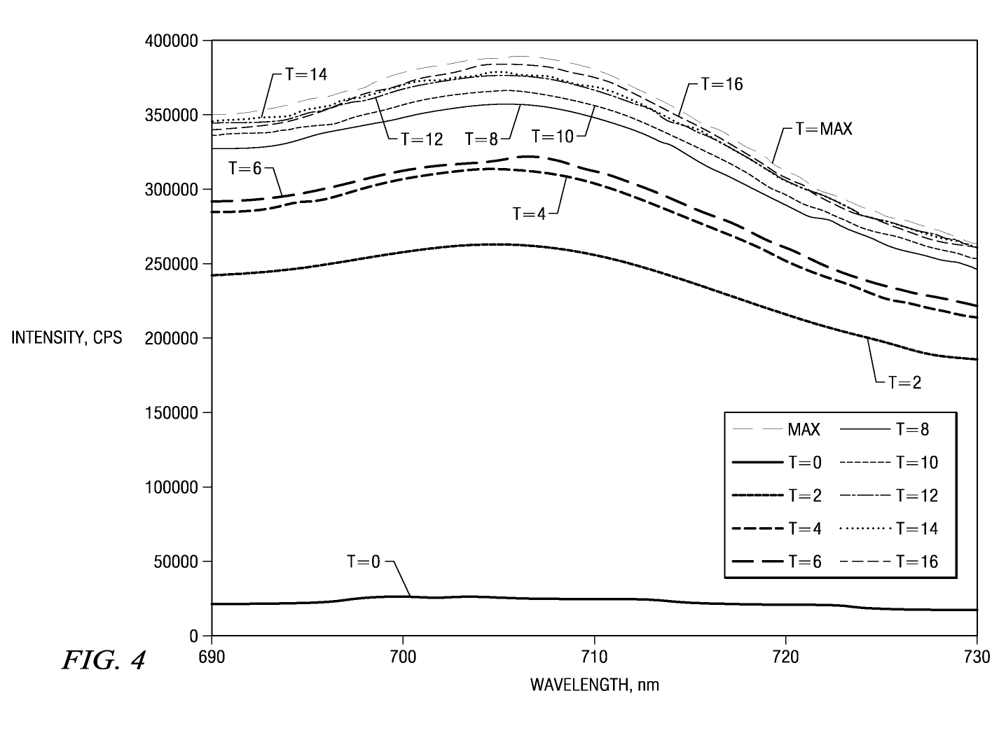

In order to induce triggered release, the liposome vesicles were activated with a light of wavelength 640 nm and the emission from the liposome vesicles was measured between 690 nm and 730 nm with an emphasis at 706 nm, which corresponds to the emission peak of ZnPc. The intensity of the signal was measured in photon counts per second (hereinafter, referred to as CPS) and the intensities were compared for each sample to determine the percentage of release. Each measurement was made with 2 seconds of exposure and a 10 nm grating under similar conditions (37° C.). The maximum intensity was measured on the ZnPc solution before it was added to the lipids during liposome synthesis. The intensity from each sample after triggered release was calculated as a percentage of the maximum intensity. FIG. 4 shows the emission spectrum from the ZnPc solution measured before the formation of the liposomes, when the intensity was maximum (Max). FIG. 4 also shows the emission at 0 mins (control experiment: no irradiation with 640 nm light) and the emission from ZnPc due to triggered release after 2 mins, 4 mins, 6 mins, 8 mins, 10 mins, 12 mins, 14 mins and 16 mins, respectively.

Table 1 shows the intensities of various samples aliquoted after regular durations of irradiation. The intensities are measured in CPS from the emission spectrum using the Fluoromax-4. The measurements of the amounts of ZnPc released indicates that after 2 minutes ˜68% of the ZnPc is released from the liposome vesicles, and that the amount released reaches near saturation (˜98%) after 12 mins of irradiation with a 640 nm light.

TABLE 1
Release kinetics of ZnPc from liposome vesicles after irradiation

| Irradiation Time (min) | Intensity (CPS) | Percentage Release |
|---|---|---|
| Max | 389000 | 100% |
| 0 | 23500 | 6% |
| 2 | 265504 | 68% |
| 4 | 312856 | 80.4% |
| 6 | 320095 | 82% |
| 8 | 357387 | 91.8% |
| 10 | 367060 | 94.3% |
| 12 | 376407 | 96.7% |
| 14 | 378056 | 97.1% |
| 16 | 383483 | 98.5% |

Such a rapid release rate is an advancement over the prior art since it is ideally suited for applications such as biological decontamination where the time to deliver the load of biocidal decontaminants is critical to preventing the spread of bacteria and spore formers.

In order further to explain the potential applications according to the invention and the mode of action of the compositions described herein, a further example is given below. The Example serves for better understanding and is in no way intended to limit the content or scope of the present invention.

### Example 2

### Neutralization of K-12 E. coli bacteria

K-12 E. coli from New England BioLabs, Inc. and a BacLight™ Live/Dead assay kit from Molecular Probes Inc. were employed in order to determine the approximate neutralization (decontamination) efficiencies of the biocides used in the liposome vesicles subjected to photo triggered release. The E. coli bacterial colonies were obtained in frozen form and diluted in a lysogeny broth (LB) medium, which is a nutritionally rich medium used for bacterial culture. The bacteria were repeatedly centrifuged and the pellet thus formed was resuspended in the same medium. The samples were diluted to a final concentration of 106 colony forming units per milliliter (hereinafter, referred to as CFUs/ml). The detailed protocol used in performing the decontamination study is described below.

A working solution of the LIVE/DEAD reagent was prepared by dissolving the contents of one pipet of SYTO 9 and one pipet of propidium iodide stains in 5 ml DI water. A 1.5 ml measure of the staining reagent was mixed with 1.5 ml of the E. coli suspension, and the sample was incubated at room temperature for 15 minutes. After 15 minutes, 500 μl of the sample was placed in a quartz cuvette, and the fluorescence emission spectrum was measured with an excitation at 470 nm and emission between 490-700 nm using the FluoroMax-4 Spectrofluorometer.

To study the decontamination efficiency, a 500 μl sample of liposomes each loaded with loaded with two kinds of biocides (peroxides and benzalkonium chloride) was added to a 500 μl sample of the E. coli suspension stained with both dyes. A sample containing the mixture was placed in a quartz cuvette and activated with light having a wavelength of 640 nm for 12 minutes (time for complete triggered release).

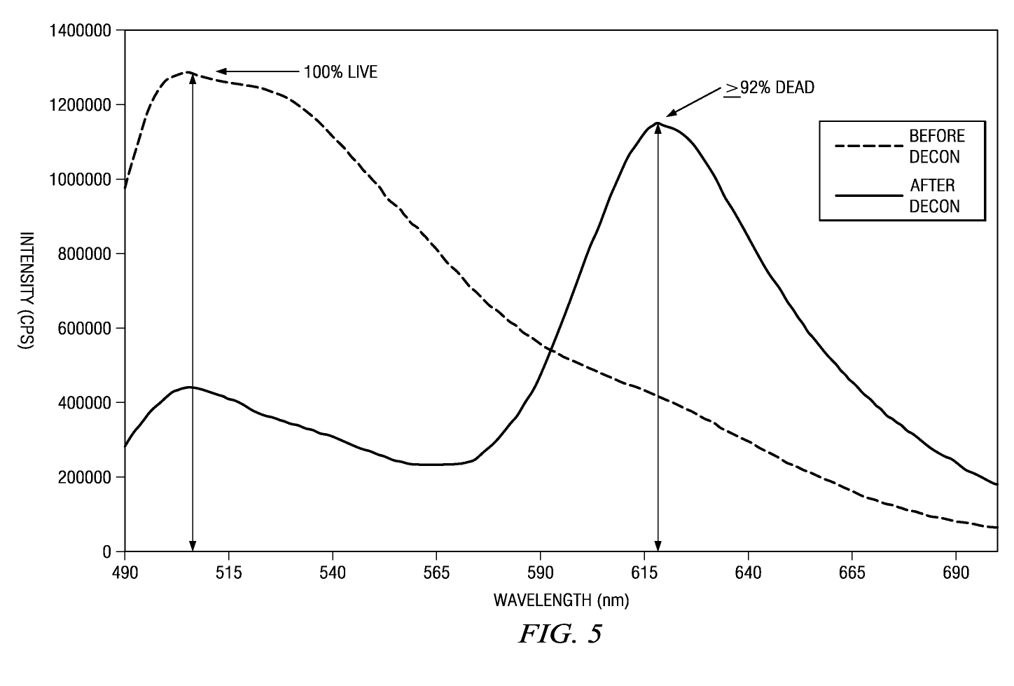

Following this, the fluorescence emission spectrum of the sample was measured with an excitation at 470 nm and emission between 490 and 700 nm. The emission spectrum was compared to the pre-activation emission spectrum to contrast the spectra before and after decontamination, as shown in FIG. 5.

In the spectra shown in FIG. 5, the peak at 510 nm corresponds to the signal from SYTO 9 (live bacteria) and the peak at 620 nm corresponds to that of the propidium iodide (dead bacteria). This is due to the fact that propidium iodide nucleic acid stain has the ability to penetrate only bacteria with damaged membranes and SYTO 9 stains both live and dead cells, preferentially live cells. Therefore, the peak at 510 nm corresponds to live and dead cells, whereas the peak at 620 nm corresponds to only dead cells.

Thus, a comparison of the two peaks (510 nm before and 620 nm after decontamination) indicates that >92% of the E. coli bacteria in the original sample are dead after exposure to the biocides released from the vesicles after just 12 minutes.

As described in and confirmed in example 1, the high efficiency decontamination of bacteria can be achieved through photo triggered release of biocidal decontaminants from liposome carriers in a rapid and automatic manner.

Furthermore, this method can be used employing several different combinations of phospholipids for liposome synthesis and combination of biocidal mixtures for achieving high efficiency on demand release and decontamination.

Moreover, other possible photosensitizers such as BChl which can be activated using a light source at a wavelength of 825 nm and bacteriochloriin which can be activated using a light source at a wavelength of 740 nm, can replace or augment ZnPc as the photosensitizer of choice while resulting in similar release times.

In summary, the invention above provides a rapidly responsive, on-demand composition and method that may be used in decontaminating a wide range of areas. The method and composition may be tailored to control the timing, type, and amount of the biocide released in response to the type and severity of the threat detected thereby reducing the time and expense of decontamination while increasing user safety.

While illustrated embodiments of the present invention have been described and illustrated in the appended drawings, the present invention is not limited thereto but only by the scope and spirit of the appended claims.

We claim:

1. A biocidal composition for sterilizing surfaces or volumes of fluids, comprising:
a plurality of liposome vesicles, each vesicle including at least one photosensitizer, and at least one biocidal agent contained in the vesicle.

2. The composition of claim 1, further including a second biocidal agent different from said at least one biocidal agent.

3. The composition of claim 2, wherein the biocidal agents include hydrogen peroxide and alkyldimethylbenzylammonium chloride.

4. The composition of claim 3, wherein the biocidal agents further include photo-oxidizing nanoparticles selected from the group consisting of Fe₂O₃ and TiO₂.

5. The composition of claim 3, wherein the alkyl group of the alkyldimethylbenzylammonium chloride is a C₁₂ to C₁₄ alkyl group.

6. The composition of claim 1, wherein the vesicle wall is a phospholipid.

7. The composition of claim 6, wherein the phospholipid is selected from the group consisting of DPPC and PlasPPC.

8. The composition of claim 1, wherein the at least one liposome vesicle is between approximately 25 nanometers and approximately 1 micron in diameter.

9. The composition of claim 1, wherein the photosensitizer is selected from the group consisting of zinc phthalocyanine, bacteriochlorophyll, and bacteriochloriin.

10. The composition of claim 1 wherein the photosensitizer activates at a wavelength of approximately 640 nm.

11. The composition of claim 1, where the composition is effective against viruses, fungi, protozoa, bacteria, spores, algae, or combinations thereof.

12. The composition of claim 1, wherein the liposome vesicle has a membrane, the photosensitizer being in the liposome vesicle membrane.

13. The composition of claim 1, wherein the plurality of vesicles comprises:
a plurality of first vesicles, each first vesicle including a first photosensitizer and containing a first biocidal agent; and
a plurality of second vesicles, each second vesicle including a second photosensitizer different from the first photosensitizer and containing a second biocidal agent different from the first biocidal agent.

14. The composition of claim 13, wherein the first photosensitizer is activated by light having a wavelength which is different from the wavelength of light that activates the second photosensitizer.

15. The composition of claim 1, wherein the plurality of liposome vesicles comprises:
a plurality of first vesicles, each first vesicle including a biocidal agent or mixture of biocidal agents and a first photosensitizer;
a plurality of second vesicles, each second vesicle including a biocidal agent or mixture of biocidal agents and a second photosensitizer; and
wherein the first photosensitizer is different from the second photosensitizer.

16. The composition of claim 15, wherein the first photosensitizer is activated by light having a wavelength which is different from the wavelength of light that activates the second photosensitizer.

17. The composition of claim 1, wherein the vesicle comprises a plurality of different phospholipids.

18. The composition of claim 1, further comprising an additive selected from the group consisting of surfactants, stabilizers, nutrients, thickeners, gels, colloids, coagulants, thinners, dyes, or mixtures thereof.

19. A method for sterilizing surfaces or volumes of fluids comprises the steps of:
formulating a composition comprising:
a plurality of liposome vesicles, each vesicle including at least one photosensitizer and at least one biocidal agent contained in the vesicle;
locating an amount of the composition in at least one area targeted for potential sterilization;
receiving an activation signal causing the activation of an irradiator;
responsive to receiving the activation signal, irradiating the composition with light having at least one wavelength causing photo-oxidation of at least some liposome vesicles and releasing their contents; and
responsive to releasing the contents of the liposome vesicles, distributing the at least one biocide over the surface or throughout the body of fluid; and
wherein releasing the contents of the liposome vesicles kills, absorbs, inhibits the growth of, prevents the spread of, decreases the toxicity of biological organisms contacted by the biocide, or otherwise decontaminates the area.

20. The method of claim 19, wherein the step of formulating a composition further includes the step of mixing the biocides to form a mixture or emulsion.

21. The method of claim 19, wherein the activation signal is a manual signal, timed signal, or signal generated in response to the detection of one or more pathogens.

22. The method of claim 19, wherein the area is a HVAC system, one or more rooms in a building, or a reservoir.

23. The method of claim 19, wherein the method of distributing the at least one biocide is through diffusion, osmosis, spraying, vaporization, or an aerosol.

24. The method of claim 19, wherein the step of formulating the composition further comprises:
using a plurality of first vesicles comprising a first biocidal agent or mixture of biocidal agents and a first photosensitizer; and
using a plurality of second vesicles, each second vesicle including a second photosensitizer different from the first photosensitizer and containing a biocidal agent.

25. The method of claim 24, wherein the first and second photosensitizers are activated individually, in a sequence, or all at the same time.

26. The method of claim 19, wherein the step of formulating the composition further comprises:
using a plurality of second vesicles, each second vesicle comprising a second biocidal agent or mixture of biocidal agents different from said at least one biocidal agent and a photosensitizer.

27. The method of claim 26, wherein the at least one photosensitizers are activated individually, in a sequence, or all at the same time.

28. The method of claim 19, wherein the percentage release of the biocide is at least approximately 70% within 2 minutes.

29. The method of claim 19, wherein the percentage release of the biocide is at least approximately 80% within 4 minutes.

30. The method of claim 19, wherein the percentage release of the biocide is at least approximately 90% within 8 minutes.

31. The method of claim 19, wherein the percentage release of the biocide is at least 95% within 12 minutes.

32. The method of claim 19, wherein the percentage release of the biocide is at least approximately 98% within 16 minutes.

33. A method for sterilizing surfaces or volumes of fluids comprises the steps of:
formulating a composition comprising:
at least one phospholipid liposome vesicle including at least one photosensitizer and at least one biocidal agent contained in the vesicle;
locating an amount of the composition in at least one area targeted for potential sterilization;
receiving a dispersion signal causing the activation of a liposome vesicle dispersion device;
responsive to receiving the dispersion signal, dispersing the liposome vesicles throughout the at least one area targeted for dispersion;
receiving an activation signal causing the activation of an irradiator;
responsive to receiving the activation signal, irradiating the composition with light having at least one wavelength causing photo-oxidation of the liposome vesicles and releasing their contents;
wherein releasing the contents of the liposome vesicles kills, absorbs, inhibits the growth of, prevents the spread of, or decreases the toxicity of biological organisms in the area.

34. The method of claim 33, wherein the composition is effective against fungi, viruses, protozoa, bacteria, spores, algae, and combinations thereof.

35. The method of claim 33, wherein the liposome vesicle dispersion device is an aerosol device, fan, blower, gravity, and combinations thereof.

36. The method of claim 33, wherein the at least one photosensitizer is activated individually, in a sequence, or all at the same time.

37. The method of claim 33, wherein the percentage release of the biocide is at least approximately 70% within 2 minutes.

38. The method of claim 33, wherein the percentage release of the biocide is at least approximately 80% within 4 minutes.

39. The method of claim 33, wherein the percentage release of the biocide is at least approximately 90% within 8 minutes.

40. The method of claim 33, wherein the percentage release of the biocide is at least 95% within 12 minutes.

41. The method of claim 33, wherein the percentage release of the biocide is at least approximately 98% within 16 minutes.

42. The method of claim 33, wherein the at least one phospholipid vesicle comprises:
using a plurality of first vesicles, each first vesicle comprising a biocidal agent or mixture of biocidal agents and a first photosensitizer,
using a plurality of second vesicles, each second vesicle comprising a biocidal agent or mixture of biocidal agents and a second photosensitizer different from the first photosensitizer.

43. The method of claim 42, wherein the first and second photosensitizers are activated individually, in a sequence, or all at the same time.

44. The method of claim 43, wherein the first and second photosensitizers are sensitive to different wavelengths of light.

45. The method of claim 33, wherein the plurality of vesicles comprises:
using a plurality of first vesicles, each first vesicle comprising a first biocidal agent or mixture of biocidal agents and a photosensitizer,
using a plurality of second vesicles, each second vesicle comprising a second biocidal agent or mixture of biocidal agents which is different from the first biocidal agent or mixture of biocidal agents and a second photosensitizer.

46. The method of claim 33, wherein the dispersion and activation signals are selected from the group of a manual signal, timed signal, or signal generated in response to the detection of one or more pathogens.
